(19) United States
(12) Patent Application Publication
(10) Pub. No.: US 2008/0115472 A1
(43) Pub. Date: May 22, 2008

(54) Filter Device, In Particular For An Exhaust-Gas System Of An Internal Combustion Engine

(76) Inventors: Bernd Reinsch, Ludwigsburg (DE); Warren Suter, Stuttgart (DE); Klaus Mueller, Tamm (DE); Teruo Komori, Aichi (JP); Lars Thuener, Stuttgart (DE)

Correspondence Address: KENYON & KENYON LLP, ONE BROADWAY, NEW YORK, NY, 10004, US

(21) Appl. No.: 11/597,456

(22) PCT Filed: Apr. 22, 2005
(86) PCT No.: PCT/EP05/51814

§ 371 Date: Nov. 16, 2007

(30) Foreign Application Priority Data
May 21, 2004 (DE) 10 2004 024 993.8
Sep. 3, 2004 (DE) 10 2004 042 730.5

(51) Int. Cl. B01D 50/00

(52) U.S. Cl. 55/385.3

(57) ABSTRACT

A filter device, in particular for an exhaust-gas system of an internal combustion engine, includes a filter structure having at least one filter wall. Filtered-out particles are deposited on its upstream surface. It is provided that the upstream-lying surface of the filter wall is at least regionally uneven.

### FIELD OF THE INVENTION

The present invention relates to a filter device, in particular for an exhaust-gas system of an internal combustion engine, the filter device having a filter structure that includes at least one filter wall made of an open-pored material on whose upstream surface filtered-out particles are deposited.

### BACKGROUND INFORMATION

A filter device of the type mentioned at the outset is known from German Published Patent Application No. 101 28 936. The filter device shown there is a particle filter for an exhaust-gas system of a diesel combustion engine. The filter walls of the known filter device are produced from sintered material and positioned in such a way that wedge-like filter pockets are formed. The wedge edges, tapering to a point, of the filter pockets point counter to the flow direction of the exhaust gas; the narrow side of a filter pocket, which is in the rear when viewed in the flow direction, is open. The filter pockets are situated next to each other in such a way that a rotationally symmetrical, ring-like filter structure comes about overall. During operation, the exhaust gas passes through the overall planar filter walls of the filter pockets, and particles are deposited on the upstream surface of the individual filter wall.

The filter walls in the known filter device are made from sintered material, which forms a porous filtration material. The sintered metal filter walls are supported in a carrier structure made from a rigid metal.

In the known filter device, the soot particles deposited on the upstream surface of the filter wall over time result in reduced permeability of the filter wall and thus lead to an increase in the pressure drop that occurs when the gas flow passes through the filter wall. The so-called “exhaust-gas counter pressure” increases correspondingly. If it exceeds a specific value the filter will be regenerated by combustion of the deposited soot particles. The temperature of the exhaust gas guided through the filter device is increased for this purpose, which in turn is effected by the injection of additional fuel.

### SUMMARY OF THE INVENTION

It is the object of the present invention to reduce the additional fuel requirement for the regeneration of the filter device.

In a filter device of the type mentioned in the introduction, this objective is achieved by the upstream surface of the filter wall being at least regionally uneven.

In the filter device according to the present invention, the upstream surface is larger than in conventional filter devices. A larger particle quantity is therefore able to be deposited there without the occurrence of an impermissible increase in the pressure drop when the flow passes through the filter wall. As a result, the filter device according to the present invention must in turn be regenerated less often than conventional filter devices, which reduces the overall fuel quantity required for the regeneration.

An essential difference to the current filter devices is that this reduction in the fuel consumption is possible without increasing the overall dimensions of the filter device. The increase in the surface area available for the deposition of particles is solely, or at least essentially, brought about by the uneven design of the surface.

This is achieved in that the upstream surface has uneven regions and thus a locally different gradient than a plane in which the wall is situated as a whole. In sintered metal structures, this is easy to achieve by appropriate design of the green body. The uneven surface provided according to the present invention thus does not entail any, or only negligible, additional cost in the production.

First of all, it is provided that the surface has wave-like projections at least regionally. In other words: The gradient of the surface differs from the gradient of the plane in which the wall is situated as a whole in only one direction, while, in a direction that is orthogonal thereto, it corresponds to the gradient of the plane in which the wall is situated as a whole in the uneven regions as well. Such a surface design is able to be produced without great expense, in particular in the case of a filter wall made of sintered material.

The expense is reduced even further if the wave-like projections have a triangular and/or sinusoidal cross section.

In this context it is provided that, with wave-like projections having a triangular cross section, the ratio between a period and an amplitude of the projections is approximately between 1 and 3, more preferably, approximately between 1 and 1.5. A ratio between 1 and 1.5 achieves a 50% enlargement of the surface area available for the deposition of filtered-out particles; a ratio of 1.5 to 3 still achieves an enlargement of at least 25%.

In an analogous manner, with wave-like projections having a sinusoidal cross section, it is suggested that the ratio between a period and an amplitude of the projections is between approximately 1 and 5.6, more preferably, between 1 and 3.7, even more preferably, between 1 and 2. With a ratio of 5.6, a 25% increase is already achieved in the effective surface area; with a value of 3.7, there is even an increase of approximately 50%, and with a value of 2, more than doubling is achieved. However, the surface may also have undulating projections, at least regionally. Compared to a planar wall, this allows an additional considerable increase in the effective surface area with identical overall dimensions of the filter device.

If the average thickness of the wall is approximately equal to the thickness of a wall having a planar surface and identical filtration capacity, the larger surface area, and subsequently the lower fuel consumption, is achieved without using more material and without the filter device according to the present invention having a greater weight than a conventional filter device. Due to the reduced use of material, the production cost is lowered as well.

It is particularly advantageous if at least the upstream surface of the filter wall has a catalytic coating. The large surface area enhances the catalytic effect, for instance in a regeneration of the filter device.

### BRIEF DESCRIPTION OF THE DRAWINGS

FIG. 1 shows a schematic illustration of an internal combustion engine having a filter device.

FIG. 2 shows a perspective illustration of the filter device of FIG. 1 with a plurality of filter pockets delimited by filter walls.

FIG. 3 shows a cut-away portion of the filter device of FIG. 2.

FIG. 4 shows a schematic illustration of a first specific embodiment of an upstream surface of a filter wall of FIG. 2.

FIG. 5 shows a representation, similar to FIG. 4, of a second exemplary embodiment.

FIG. 6 shows a representation, similar to FIG. 4, of a third exemplary embodiment.

FIG. 7 shows a representation, similar to FIG. 4, of a fourth exemplary embodiment.

FIG. 8 shows a representation, similar to FIG. 4, of a fifth exemplary embodiment.

FIG. 9 shows a diagram on which the ratio of the surface area of FIG. 5 and a planar surface area has been plotted for different amplitudes and periods.

FIG. 10 shows a diagram, similar to FIG. 9, for the surface area shown in FIG. 4.

### DETAILED DESCRIPTION

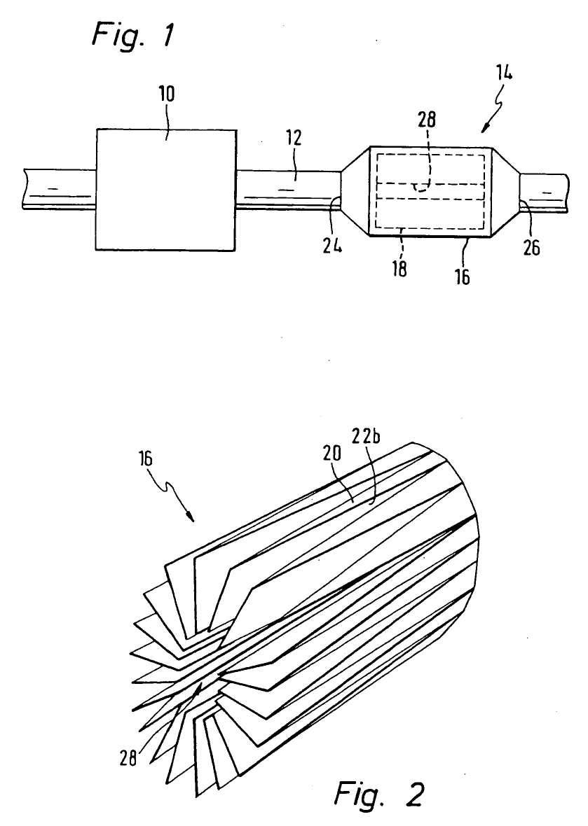

In FIG. 1, an internal combustion engine is denoted by reference numeral 10. The exhaust gases are carried via an exhaust pipe 12 in which a filter device 14 is disposed. It is used to filter soot particles out of the exhaust gas flowing inside exhaust pipe 12. This is required with diesel engines, in particular, in order to comply with legal provisions.

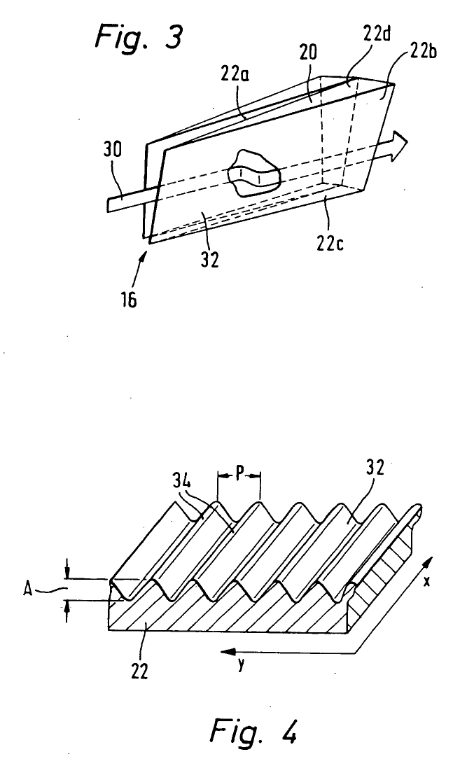

Filter device 14 includes a cylindrical housing 16 in which a filter structure 18 is disposed, which in the present exemplary embodiment is a rotationally symmetrical, generally also cylindrical filter structure. It includes a multitude of wedge-shaped filter pockets of which only one has been provided with reference numeral 20 in FIG. 2. This filter pocket and an adjacent filter pocket are shown once again in an enlarged view in FIG. 3.

Each wedge-shaped filter pocket 20 has two lateral filter walls 22a and 22b. The left or front edges (in FIGS. 2 and 3) of filter walls 22a and 22b of a filter pocket 20, which face an inlet 24 of housing 16, are interconnected, whereas the right or rear edges (in FIGS. 2 and 3) of filter walls 22a and 22b of a filter pocket 20, which face an outlet 26 of housing 16, are set apart from each other. This results in the wedge shape of filter pockets 20. In the radially inward and radially outward direction, filter pockets 20 are sealed by filter wall sections 22c and 22d, which are triangular overall.

In the discussed exemplary embodiment, filter pockets 20 are disposed about a centrical channel-like flow chamber 28 in the form of a ring and sealed from each other. This flow chamber 28 is sealed at its rear and not visible end (in FIG. 2) by a sealing plate. With respect to housing 16, filter structure 18 is sealed by sealing device (not shown further) in the region of its rear end in FIG. 2 as well.

Filter walls 22 forming filter pockets 20 and ultimately filter structure 18, are produced on a sintered metal base. This is an open-pored and gas-permeable structure, which filters soot particles out of the gas flow when the flow passes through filter walls 22. A corresponding gas flow is indicated by arrow 30 in FIG. 3. The purified gas flow leaves filter pockets 20 via their right (in FIG. 2) or rear (FIG. 3) open end. During operation of filter device 14 the soot particles filtered out of the gas flow are deposited on the individual surfaces of filter walls 20 delimiting filter walls 20 in the upstream direction when viewed in the direction of gas flow 30. In FIG. 3 this surface is denoted by 32 on filter wall 22b by way of example. Although filter walls 22 as a whole are straight they have individual uneven regions whose possible forms are shown in detail in FIGS. 4 through 8. In a first specific embodiment, which is shown in FIG. 4, the upstream surface 32 of a filter wall 22 has a multitude of parallel wave-like projections 34 which have a sinusoidal cross section. The gradient of surface 32 in the specific embodiment shown in FIG. 4 thus changes only in the Y-direction, but not in the X-direction.

Another specific embodiment, which is shown in FIG. 5, also has wave-like projections 34, which have a triangular cross section, however. Here, too, the gradient of surface 32 changes only in the Y-direction, but not in the X-direction:

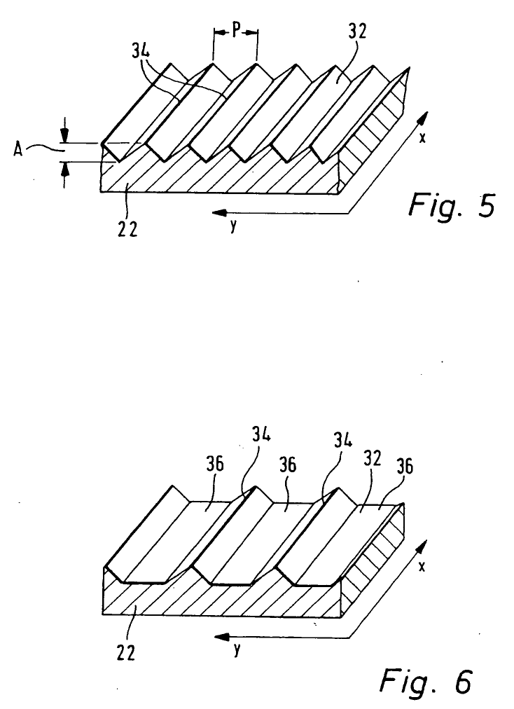

A variant to FIG. 5 is shown in FIG. 6. Here, too, there are wave-like projections 34 having a triangular cross section, but these do not abut each other directly; instead, a planar region 36 that is parallel to wave-like projections 34 is present between them.

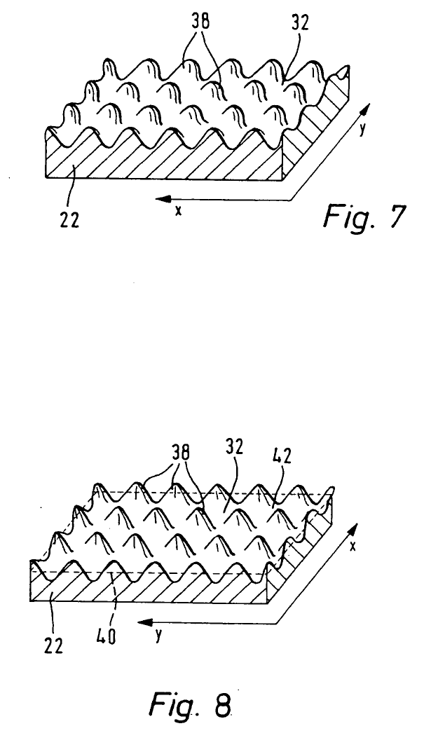

Another different specific embodiment of a surface 32 is shown in FIG. 7. In this case, surface 32 has a multitude of undulating projections 38. These may have a conical, pyramidal, pointed or rounded form, for example.

In FIG. 8 the surface of a conventional filter wall is indicated by a dashed line bearing reference numeral 40. Undulating projections 38 are so high, and “valleys” 42 between undulating projections 38 so deep that the average thickness of filter wall 22 in the exemplary embodiment shown in FIG. 8 corresponds approximately to the thickness of a conventional planar filter wall 22.

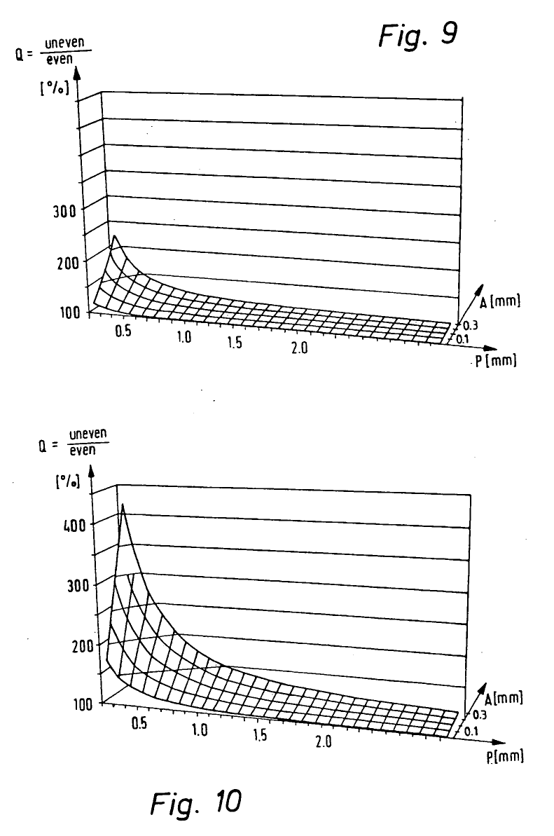

In FIG. 9, a quotient Q is plotted above a period P and an amplitude A of a surface 32 of a filter wall 22 for the specific embodiment shown in FIG. 5. Quotient Q is formed by effective area Fᵤₙₑᵥₑₙ, which is available on uneven surface 32 in FIG. 5 for the deposition of soot particles, and a surface Fₑᵥₑₙ, which would be available on a conventional planar surface (given an identical area in a plan view). It can be seen that a quotient Q of 125% is obtained already with a period of 0.8 mm and an amplitude of 0.3 mm, and that a quotient of 150% is achieved with a period of 0.5 mm and an amplitude of 0.3 mm.

FIG. 10 shows a similar diagram, but for the exemplary embodiment of FIG. 4, in which wave-like projections 34 have a sinusoidal cross section. In that case, a quotient Q of 125% is achieved already with an amplitude A of 0.3 mm and a period P of 1.7 mm; a quotient Q of 150% at an amplitude A of 0.3 mm and a period P of 1.1 mm; and a quotient Q of 200%, i.e., doubling of the effective surface, at an amplitude A of 0.3 mm and a period P of 0.7 mm.

Period P of the surface structures is preferably between 0.3 mm and 3 mm, amplitude A is preferably between 0.1 and 0.3 mm.

The filter device may be a sintered metal filter or also a comparable ceramic filter that likewise includes a porous filter medium.

During production of the filter, this porous filter medium, for which metal powder may be used as base material in the case of sintered metal filters, or ceramic powder for ceramic filters, is applied on a rigid metal supporting base such as woven metal fabric or metal mesh, or on comparable ceramic fiber layers in the case of ceramic filters, and joined to the metal or ceramic supporting base under the action of heat. In the process, the porous filter medium is joined to the supporting base in such a way that the filter surface has a three-dimensional form, i.e., the afore-described waves, or hills and valleys. It may be advantageous to select for the surface structure a period that is equal to the period of the support structure (for instance in the case of a woven metal fabric), or it may be advantageous to select the period of the support structure according to a period, to be set, of the surface structure. In this way the valleys may be positioned in the gaps of the woven structure and the hills on the connecting fibers of the woven or support structure.

The filter device according to the present invention may also be composed of materials other than sintered metals or ceramics, for instance metal or ceramic foams, or a fiber composite made of metal fiber, in particular.

1.-9. (canceled)

10. A filter device for an exhaust-gas system of an internal combustion engine, comprising:
a filter structure that includes at least one filter wall on whose upstream surface filtered-out particles are deposited, wherein the upstream-lying surface of the filter wall is at least regionally uneven.

11. The filter device as recited in claim 10, wherein, at least regionally, the surface has wave-like projections.

12. The filter device as recited in claim 11, wherein the wave-like projections have a triangular and/or sinusoidal cross section.

13. The filter device as recited in claim 12, wherein, with wave-like projections having a triangular cross section, the ratio between a period and an amplitude of the projections is approximately between 1 and 3.

14. The filter device as recited in claim 12, wherein, with wave-like projections having a triangular cross section, the ratio between a period and an amplitude of the projections is approximately between 1 and 1.5.

15. The filter device as recited in claim 13, wherein, with wave-like projections having a sinusoidal cross section, the ratio between a period and an amplitude of the projections is approximately between 1 and 5.6.

16. The filter device as recited in claim 13, wherein, with wave-like projections having a sinusoidal cross section, the ratio between a period and an amplitude of the projections is approximately between 1 and 3.7.

17. The filter device as recited in claim 13, wherein, with wave-like projections having a sinusoidal cross section, the ratio between a period and an amplitude of the projections is approximately between 1 and 2.

18. The filter device as recited in claim 10, wherein, at least regionally, the surface has undulating projections.

19. The filter device as recited in claim 10, wherein an average thickness of the filter wall is approximately identical to the thickness of a filter wall having a planar surface and the same filtration capacity.

20. The filter device as recited in claim 10, wherein at least the upstream-lying surface of the filter wall has a catalytic coating.

21. The filter device as recited in claim 10, wherein the at least one filter wall has a porous and gas-permeable material.
